(19) United States
(12) Patent Application Publication
(10) Pub. No.: US 2026/0170204 A1
(43) Pub. Date: Jun. 18, 2026

(54) METHOD AND SYSTEM FOR RAPIDLY PREDICTING GAS ADSORPTION PROPERTY OF MATERIAL BASED ON ARTIFICIAL INTELLIGENCE

(71) Applicant: Suzhou Laboratory, Jiangsu (CN)

(72) Inventors: Chenkai GU, Jiangsu (CN); Jing ZHONG, Jiangsu (CN); Weihong XING, Jiangsu (CN)

(73) Assignee: Suzhou Laboratory, Jiangsu (CN)

(21) Appl. No.: 19/415,810

(22) Filed: Dec. 11, 2025

(30) Foreign Application Priority Data
Dec. 16, 2024 (CN) 202411853232.1

(51) Int. Cl. G06F 30/27; G06F 113/08

(52) U.S. Cl. CPC G06F 30/27; G06F 2113/08

(57) ABSTRACT

The present disclosure relates to the technical field of computational materials science, and in particular to a method and a system for rapidly predicting a gas adsorption property of a material based on artificial intelligence. The present disclosure innovatively adopts a simulation-experiment-integrated descriptor, namely gas adsorption isotherm, combined with an innovatively proposed query sampling strategy. The present disclosure can acquire the adsorption property of a material for one or more other gases only by inputting the adsorption data of the material for one gas acquired through an experiment or simulation. Therefore, the present disclosure reduces the research and development costs of adsorption materials and improves research and development efficiency.

### CROSS REFERENCE TO THE RELATED APPLICATIONS

This application claims priority benefit of Chinese application serial no. 202411853232.1, filed on Dec. 16, 2024. The entirety of the above-mentioned patent application is hereby incorporated by reference herein and made a part of this specification.

### TECHNICAL FIELD

The present disclosure relates to the technical field of materials science, and in particular to a method and a system for rapidly predicting a gas adsorption property of a material based on artificial intelligence.

### BACKGROUND

The research and development of materials for gas adsorption is of great significance to industries such as petrochemical engineering, environmental protection, and biomedicine. By innovating and improving the gas adsorption properties of the materials, key gases can be processed and separated effectively in applications such as carbon dioxide capture and storage, pollutant control, and purification of hydrogen and natural gas. These applications represent crucial technologies for enabling the transition to clean energy and achieving sustainable development goals. Currently, the gas adsorption properties of materials can be evaluated through two methods: experimental evaluation and simulation evaluation. The experimental evaluation includes tasks such as material synthesis, characterization, and testing, while the simulation evaluation includes tasks such as model construction and force field selection. However, both methods suffer from some limitations. Therefore, there is a need for an efficient method and an efficient system for evaluating gas adsorption properties of materials to help researchers reduce material research and development costs and improve research and development efficiency.

The limitations of the experimental and simulation methods for evaluating gas adsorption properties of materials are as follows. The entire process of the experimental evaluation method includes material synthesis, characterization, testing, and other tasks. It involves numerous tests to evaluate more than one gas adsorption property of a material, resulting in a long cycle and a high cost. In contrast, the simulation evaluation method encounters challenges in material modeling. Many materials have complex compositions and unclear inherent regularities, making it impossible to extract appropriate structural data for modeling, thereby rendering simulations unfeasible. In addition, the accuracy of gas parameters plays a dominant role in the reliability of simulation results. However, currently only the parameters of a small number of gases are relatively accurate, which also limits the application scope of using simulation methods to evaluate gas adsorption properties of materials.

### SUMMARY

To solve the problems of long experimental cycles, high costs, difficult simulation modeling, and limited application scopes, the present disclosure innovatively adopts a simulation-experiment-integrated descriptor, namely gas adsorption isotherm, combined with an innovatively proposed query sampling strategy. The present disclosure employs an artificial intelligence technology to establish an efficient method and an efficient system for evaluating a gas adsorption property of a material. The present disclosure effectively reduces the research and development costs of adsorption materials and improves research and development efficiency. In summary, the present disclosure proposes a method and a system for rapidly predicting a gas adsorption property of a material based on artificial intelligence, solving the problems described in the above background.

In order to achieve the above objective, the present disclosure provides the following technical solutions:

A method for rapidly predicting a gas adsorption property of a material based on artificial intelligence includes following steps:
S1: acquiring, by a user, gas adsorption property data of the material, and determining a gas adsorption property label to be predicted; and retrieving gas adsorption property data of same-type materials from a database for analysis, and dividing the gas adsorption property data of the same-type materials into a training set and a validation set; and
S2: constructing a prediction model based on the training set, and validating the prediction model based on the validation set to obtain a validated prediction model; and predicting, by the validated prediction model, the gas adsorption property of the material;
where, the gas adsorption property data retrieved from the database includes gas adsorption property data corresponding to the gas adsorption property of the material and gas adsorption property data corresponding to the gas adsorption property label to be predicted.

The gas adsorption property refers to one of an adsorption capacity, an adsorption rate, and a desorption rate for a predetermined gas type under a predetermined parameter condition; and the gas adsorption property label to be predicted refers to gas adsorption properties under different parameter conditions and/or for different gas types.

The different parameter conditions refer to different temperatures and/or different pressures.

A number of types of the same-type materials retrieved from the database is greater than or equal to a number of types of the material acquired by the user.

The same-type materials refer to materials corresponding to an upper-level concept formed by classifying materials acquired by the user in terms of type.

A gas type is one selected from a group consisting of methane, ethane, n-hexane, toluene, ethyl acetate, nitrogen, argon, carbon dioxide, ethylene, propylene, butylene, methanol, ethanol, acetone, chloroform, benzene, xylene, carbon tetrachloride, ammonia, hydrogen sulfide, carbon monoxide, oxygen, ozone, chlorine, fluorine, bromine, iodomethane, and styrene.

A type of the material is one selected from a group consisting of activated carbon, metal-organic framework, covalent organic framework, molecular sieve, carbon nanotube, ceramic, and porous coordination polymer.

The dividing of the gas adsorption property data of the same-type materials into the training set and the validation set includes: randomly selecting a part of the gas adsorption property data of the same-type materials as an initial set, selecting and supplementing a part of remaining gas adsorption property data with a lower similarity to the initial set into the initial set to obtain the training set, and taking a remaining part of the remaining gas adsorption property data as the validation set.

A similarity is calculated by summing a similarity of a normalized adsorption isotherm and a saturated adsorption capacity similarity coefficient.

The similarity of the normalized adsorption isotherm is calculated from two sets of adsorption isotherm data as follows:

$${ρ}_{i} = \frac{1}{n} {\sum }_{j = 1}^{n} {ρ}_{i , j}$$

$${ρ}_{i , j} = \frac{cov ( i , j )}{{σ}_{i} {σ}_{j}} = \frac{E ( ( i - {μ}_{i} ) ( j - {μ}_{j} ) )}{{σ}_{i} {σ}_{j}} = \frac{E ( i , j ) - E ( i ) E ( j )}{\sqrt{E ( {i}^{2} ) - {E}^{2} ( i )} \sqrt{E ( {j}^{2} ) - {E}^{2} ( j )}}$$

where, ρᵢ denotes the similarity of the normalized adsorption isotherm; ρ_{i,j} denotes a Pearson correlation coefficient of the two sets of adsorption isotherm data; cov(i,j) denotes a covariance of the two sets of adsorption isotherm data; σᵢ and σⱼ denote standard deviations of the two sets of adsorption isotherm data, respectively; E denotes an expectation; i and j denote the two sets of adsorption isotherm data, respectively; μᵢ and μⱼ denote expectations of the two sets of adsorption isotherm data, respectively; and n denotes a number of samples in the training set.

The saturated adsorption capacity similarity coefficient is calculated as follows:

$${φ}_{i} = 1 - \frac{1}{n} {\sum }_{j = 1}^{n} Δ {Q}_{i , j} / MAX ( Δ {Q}_{i , j} )$$

$$Δ {Q}_{i , j} = \vert {Q}_{i} - {Q}_{j} \vert$$

where, φᵢ denotes the saturated adsorption capacity similarity coefficient; MAX denotes a maximum value; Qᵢ and Qⱼ denote saturated adsorption capacities of the two sets of adsorption isotherm data i and j, respectively; ΔQ_{i,j} denotes a difference in the saturated adsorption capacities; and n denotes the number of samples in the training set.

The method includes: fitting the gas adsorption property data acquired by the user and/or the gas adsorption property data retrieved from the database through a gas adsorption equation, and generating gas adsorption property data under another condition.

The method further includes: determining completeness of the gas adsorption property data acquired by the user by fitting the gas adsorption property data acquired by the user through a gas adsorption equation, determining whether a fitting degree meets a threshold requirement, and determining that the gas adsorption property data acquired by the user is complete if the threshold requirement is met.

Whether the threshold requirement is met is determined by determining whether the adsorption property data acquired by the user matches a common adsorption curve, that is, whether a relatively smooth curve is formed; a determination method includes fitting the gas adsorption property data acquired by the user with a common adsorption equation and determining whether the fitting degree meets a predetermined value; the gas adsorption equation is one selected from a group consisting of Langmuir equation, Brunauer-Emmett-Teller (BET) equation, Freundlich equation, Temkin equation, Dubinin-Radushkevich equation, Toth equation, Sips equation, or Zeta adsorption model; and the fitting degree is measured through one of determination coefficient, mean squared error, root mean squared error, mean absolute error, mean absolute percentage error, residual, Akaike information criterion (AIC), or Bayesian information criterion (BIC).

A system for rapidly predicting a gas adsorption property of a material based on artificial intelligence includes:
a user terminal, configured for a user to acquire gas adsorption property data of the material and determine a gas adsorption property label to be predicted;
a data storage and processing module, configured to extract gas adsorption property data of same-type materials and divide the gas adsorption property data of the same-type materials into a training set and a validation set; and
an artificial intelligence training and prediction module, configured to construct a prediction model based on the training set and validate the prediction model based on the validation set,
where, the gas adsorption property data acquired by the user and/or the gas adsorption property data retrieved from the database include gas adsorption property data corresponding to the gas adsorption property label to be predicted.

The gas adsorption property refers to one of an adsorption capacity, an adsorption rate, and a desorption rate for a predetermined gas type under a predetermined parameter condition; and the gas adsorption property label to be predicted refers to gas adsorption properties under different parameter conditions and/or for different gas types.

The user terminal further includes a determination unit configured to determine completeness of the gas adsorption property data acquired by the user by fitting the gas adsorption property data acquired by the user through a gas adsorption equation, determining whether a fitting degree meets a threshold requirement, and determining that the gas adsorption property data acquired by the user is complete if the threshold requirement is met.

The data storage and processing module further includes a secondary acquisition unit configured to fit the gas adsorption property data acquired by the user and/or the gas adsorption property data retrieved from the database through the gas adsorption equation, and generate gas adsorption property data under another condition.

The data storage and processing module further includes a training-validation set splitting unit configured to randomly select a part of the gas adsorption property data of the same-type materials as an initial set, select and supplement a part of remaining gas adsorption property data with a lower similarity to the initial set into the initial set to obtain the training set, and take a remaining part of the remaining gas adsorption property data as the validation set.

The artificial intelligence training and prediction module further includes a model evaluation unit configured to compare performances of prediction models trained based on different artificial intelligence models.

### BRIEF DESCRIPTION OF THE DRAWINGS

FIG. 1 is a schematic structural diagram of a system for rapidly predicting a gas adsorption property of a material based on artificial intelligence according to an embodiment of the present disclosure;

FIG. 2 is a schematic diagram of a user terminal in the system for rapidly predicting a gas adsorption property of a material based on artificial intelligence according to an embodiment of the present disclosure;

FIG. 3 is a schematic diagram of a data storage and processing module in the system for rapidly predicting a gas adsorption property of a material based on artificial intelligence according to an embodiment of the present disclosure;

FIG. 4 is a schematic diagram of an artificial intelligence training and prediction module in the system for rapidly predicting a gas adsorption property of a material based on artificial intelligence according to an embodiment of the present disclosure;

FIG. 5 is a flowchart of a method for rapidly predicting a gas adsorption property of a material implemented by an artificial intelligence service system according to an embodiment of the present disclosure; and

FIGS. 6A, 6B and 6C are comparison of effects before and after optimizing a training set through a sampling strategy according to an embodiment of the present disclosure, where 6A shows a true value, 6B shows a prediction result of a model before optimizing the training set through the sampling strategy, and 6C shows a prediction result of the model after optimizing the training set through the sampling strategy.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

The present disclosure provides a method and a system for rapidly predicting a gas adsorption property of a material based on artificial intelligence. According to the actual situation of using gas adsorption isotherm as a descriptor, the present disclosure innovatively defines a brand-new sampling strategy. Based on the sampling strategy, the present disclosure can optimize a training set in one step, thereby improving the accuracy of an artificial intelligence model. In this way, the present disclosure can achieve accurate prediction, reduce material research and development costs, and improve research and development efficiency.

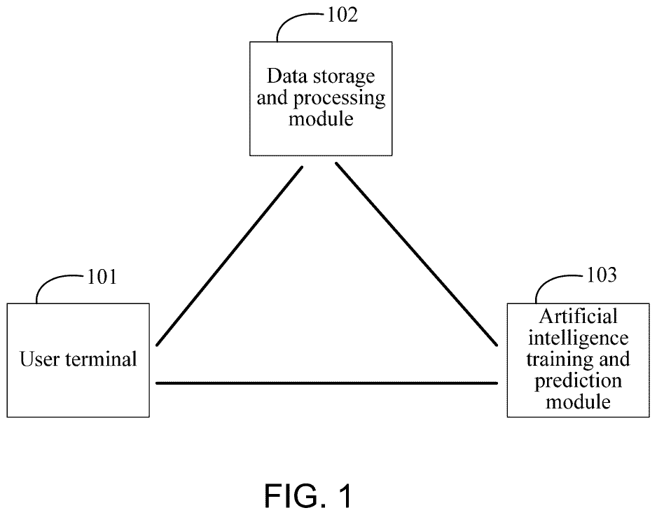

As shown in FIG. 1, an embodiment of the present disclosure provides an artificial intelligence service system, including: a user terminal 101, a data storage and processing module 102, and an artificial intelligence training and prediction module 103. The user terminal 101 is connected to the data storage and processing module 102 and the artificial intelligence training and prediction module 103. The data storage and processing module 102 is connected to the user terminal 101 and the artificial intelligence training and prediction module 103. The artificial intelligence training and prediction module 103 is connected to the user terminal 101 and the data storage and processing module 102. The user terminal 101 is configured to perform data acquisition, data evaluation, and human-computer interaction, send information to the data storage and processing module 102, and receive and display a data output from the artificial intelligence training and prediction module 103. The data storage and processing module 102 is configured to perform data storage, data extraction, data fitting, and secondary data acquisition, divide a training set and a test set, and transmit the training set and the test set to the artificial intelligence training and prediction module 103. The artificial intelligence training and prediction module 103 is configured to train an artificial intelligence model, realize the prediction of one or more adsorption properties of a target material, and transmit data to the user terminal 101 for display and output.

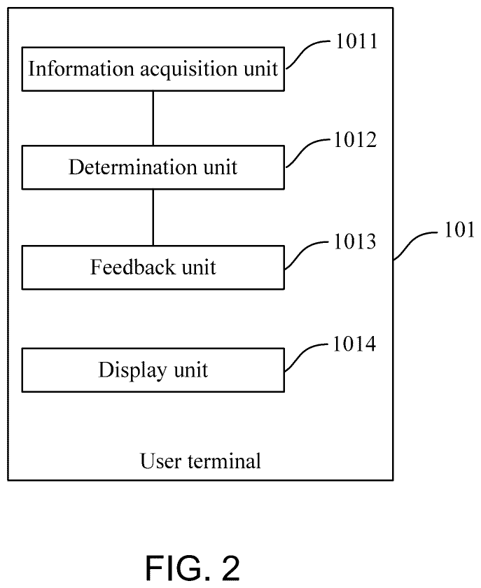

Preferably, as shown in FIG. 2, in an embodiment of the present disclosure, the user terminal 101 includes: an information acquisition unit 1011, a determination unit 1012, a feedback unit 1013, and a display unit 1014. The information acquisition unit 1011 is configured to acquire gas adsorption property data of a material from a user and determine one or more gas adsorption property labels to be predicted. The gas adsorption property may include adsorption capacity, working capacity, desorption rate, etc. The determination unit 1012 is configured to determine whether the data meets a condition, that is, whether it can be smoothly connected into a curve. The feedback unit 1013 is configured to feed back a data supplement suggestion to the user or transmit data meeting the condition to the data storage and processing module 102. The display unit 1014 is configured to receive data from the artificial intelligence training and prediction module 103 and display the data.

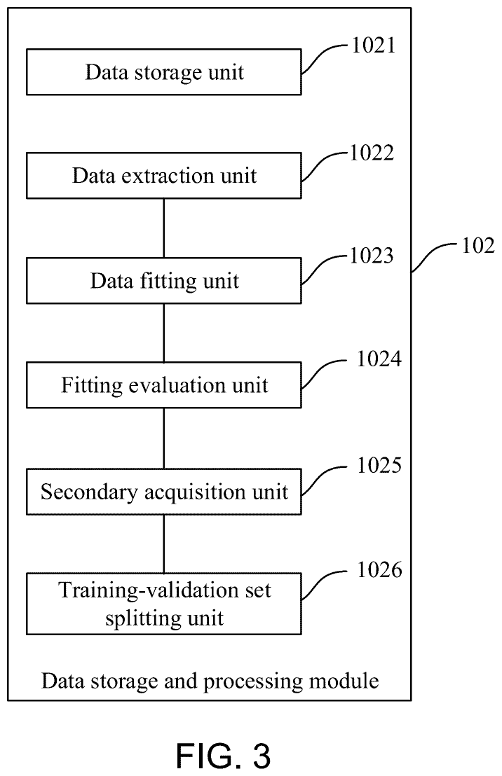

Preferably, as shown in FIG. 3, the data storage and processing module 102 includes: a data storage unit 1021, a data extraction unit 1022, a data fitting unit 1023, a fitting evaluation unit 1024, a secondary acquisition unit 1025, and a training-validation set splitting unit 1026. The data storage unit 1021 is configured to store adsorption data acquired from the user terminal and a large amount of existing data for training the artificial intelligence model. The data extraction unit 1022 is configured to extract corresponding data information of a same-type material in a database and corresponding data information of the gas adsorption property labels to be predicted (for example, gas adsorption property data and gas adsorption property labels for a gas under a same temperature condition) according to the data information acquired from the user and the gas adsorption property labels to be predicted. The data acquired by the user may include data of a predetermined adsorption property under one parameter condition, and the user requests prediction of corresponding adsorption property data under another parameter condition, or the user requests prediction of another adsorption property data under the same parameter condition (or a combination of both). In addition to the information corresponding to the property data acquired by the user, the database further includes data corresponding to the gas adsorption property labels desired by the user, thereby associating data results of different parameter conditions or different property labels. The materials in the database may be of the same type (i.e., upper-level concept) as the materials acquired by the user. For example, if the user acquires data of a specific metal-organic framework (MOF) material, the same-type materials in the database refer to all MOF materials, ensuring that the number of types of same-type materials retrieved from the database is greater than or equal to the number of types of materials acquired by the user. The data fitting unit 1023 is configured to fit the extracted adsorption data through a plurality of methods. The fitting evaluation unit 1024 is configured to compare fitting effects of a plurality of fitting methods and provide a basis for the selection of fitting methods. The secondary acquisition unit 1025 is configured to perform secondary data acquisition. The training-validation set splitting unit 1026 is configured to divide the training set and the test set according to a sampling strategy defined by the present disclosure and transmit the training set and the test set to the artificial intelligence training and prediction module 103.

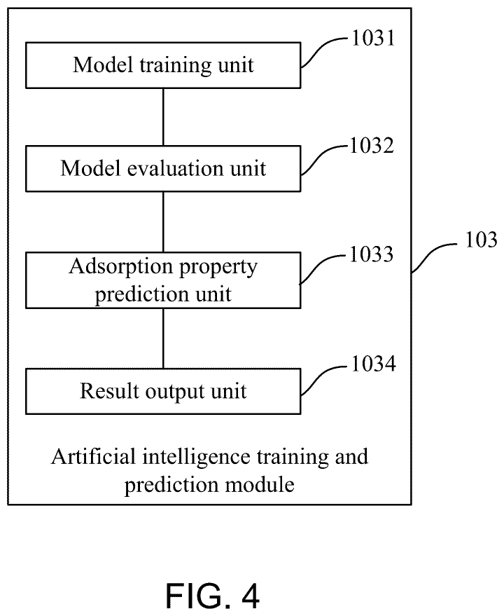

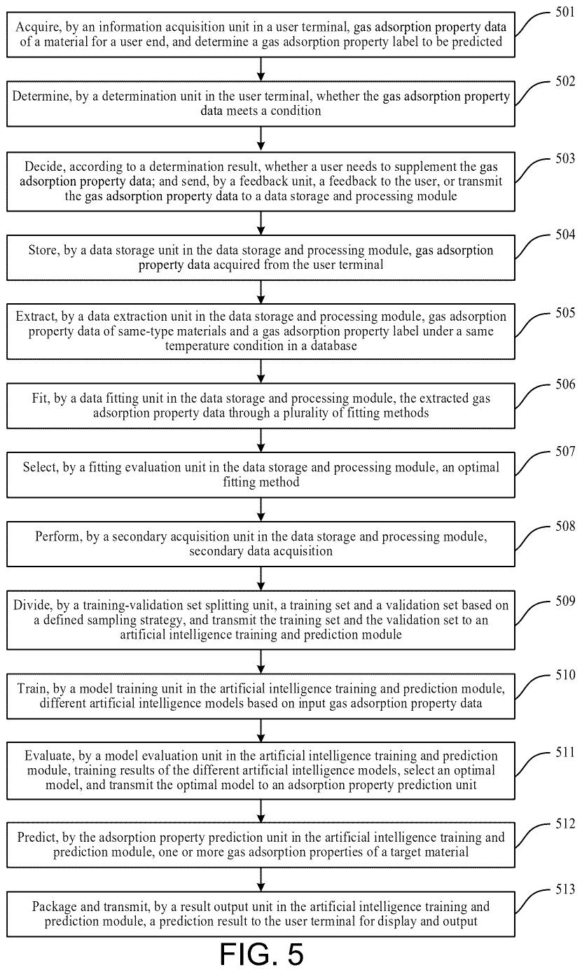

Preferably, as shown in FIG. 4, the artificial intelligence training and prediction module 103 includes: a model training unit 1031, a model evaluation unit 1032, an adsorption property prediction unit 1033, and a result output unit 1034. The model training unit 1031 is configured to train a plurality of different artificial intelligence models based on input adsorption data. The model evaluation unit 1032 is configured to evaluate training results of the plurality of different artificial intelligence models, select an optimal model, and transmit the optimal model to the adsorption property prediction unit 1033. The adsorption property prediction unit 1033 is configured to predict one or more adsorption properties of the target material. The result output unit 1034 is configured to package and transmit a prediction result to the user terminal for display and output.

In the above embodiment, the data storage unit 1021 stores more than 150,000 material structures and corresponding gas adsorption isotherm data. The gas types include carbon dioxide (CO₂) (about 710,000 entries), nitrogen (N₂) (about 380,000 entries), methane (CH₄) (about 850,000 entries), hydrogen (H₂) (about 280,000 entries), and n/i-butane (about 24,000 entries). The stored material types include MOFs (about 150,000 types), covalent organic frameworks (COFs) (811 types), zeolites (216 types), and amorphous porous carbon materials (614 types).

In a second aspect, the present disclosure provides a method for rapidly predicting a gas adsorption property of a material by employing the artificial intelligence service system described in the first aspect, including following steps. Step 501, the user terminal acquires gas adsorption property data of a material and determines one or more gas adsorption property labels to be predicted. Step 502, the determination unit of the user terminal determines whether the data meets a condition. Generally, it is determined whether the adsorption property data matches a common adsorption curve, that is, whether a relatively smooth curve is formed. The determination can be implemented by fitting the adsorption data with a common adsorption equation and determining whether a fitting degree meets a predetermined value. The common adsorption equation may include: Langmuir equation, Brunauer-Emmett-Teller (BET) equation, Freundlich equation, Temkin equation, Dubinin-Radushkevich equation, Toth equation, Sips equation, Zeta adsorption model, etc. The fitting degree can be measured using some common indicators, such as: determination coefficient (R²), mean squared error (MSE), root mean squared error (RMSE), mean absolute error (MAE), mean absolute percentage error (MAPE), residual, Akaike information criterion (AIC), and Bayesian information criterion (BIC). Step 503, it is determined whether the user needs to supplement data according to a determination result. The determination criterion here can be realized by setting a threshold for the fitting degree, such as R²>0.8, MAE<0.1, etc. The threshold can be adjusted according to factors such as material, temperature, pressure, and gas type. If the condition is not met, the feedback unit feeds back the result to the user and requires the user to supplement adsorption data under more pressures (target pressure points can be calculated by a bisection method). If the condition is met, the data is transmitted to the data storage and processing module. Step 504, the data storage unit of the data storage and processing module stores the adsorption data acquired from the user terminal. Step 505, the data extraction unit of the data storage and processing module extracts adsorption data of same-type materials in the database for the gas under the same temperature condition and gas adsorption property labels. The same-type materials here may refer to the upper-level type relative to the material when the user acquires data. For example, the same-type materials of a specific MOF material refer to all MOF materials. Step 506, the data fitting unit of the data storage and processing module fits the extracted adsorption data through a plurality of methods. Step 507, the fitting evaluation unit of the data storage and processing module selects an optimal fitting method. Step 508, the secondary acquisition unit of the data storage and processing module performs secondary data acquisition. Step 509, the training set and the test set are divided based on an innovatively defined sampling strategy and are transmitted to the artificial intelligence training and prediction module. Step 510, the model training unit of the artificial intelligence training and prediction module trains different artificial intelligence models based on the input adsorption data. Step 511, the model evaluation unit of the artificial intelligence training and prediction module evaluates training results of the different artificial intelligence models, selects an optimal model, and transmits the optimal model to the adsorption property prediction unit. Step 512, the adsorption property prediction unit of the artificial intelligence training and prediction module predicts one or more adsorption properties of the target material. Step 513, the result output unit of the artificial intelligence training and prediction module packages and transmits a prediction result to the user terminal for display and output.

The present disclosure defines a brand-new sampling method, which is deployed in the training-validation set splitting unit of the data storage and processing module. Based on the sampling method, the training set can be optimized in one step before the start of model training. It specifically includes three steps. 1. The input isotherm data are processed one by one, the saturated adsorption capacity of each isotherm is extracted, and the isotherm is normalized. 2. The gas adsorption property data of materials retrieved from the database are analyzed, the training set and validation set are divided, 60% of the materials are randomly selected to form an initial set, the adsorption data of each of the remaining 40% of the materials are compared with the adsorption data of each material in the initial set one by one, and similarities are calculated. 3. The similarities are sorted from low to high, a first half of the materials (i.e., 20% of the total) is selected and their data are added to the initial set to form an optimized training set (accounting for 80% of the total), and the rest forms the test set, and the training set and the test set are transmitted to the artificial intelligence training and prediction module. It should be noted that the proportion of material division in the process of optimizing the data set is not fixed and can be adjusted according to actual conditions.

In a fourth aspect, the key of the sampling method innovatively proposed by the present disclosure lies in similarity calculation. For a given material i, the similarity between its adsorption data and the adsorption data of materials in the initial set (a total of n materials) includes two parts: 1. the similarity of the normalized adsorption isotherm, namely ρᵢ, and 2. the saturated adsorption capacity similarity coefficient, namely φᵢ. The sum of the two parts serves as a comparison value of similarity. The similarity here takes into account two aspects of the adsorption isotherm, namely the curve type and the saturated adsorption capacity, both of which are indispensable.

The similarity ρᵢ of the normalized adsorption isotherm is calculated as follows:

$${ρ}_{i} = \frac{1}{n} {\sum }_{j = 1}^{n} {ρ}_{i , j}$$

$${ρ}_{i , j} = \frac{cov ( i , j )}{{σ}_{i} {σ}_{j}} = \frac{E ( ( i - {μ}_{i} ) ( j - {μ}_{j} ) )}{{σ}_{i} {σ}_{j}} = \frac{E ( ij ) - E ( i ) E ( j )}{\sqrt{E ( {i}^{2} ) - {E}^{2} ( i )} \sqrt{E ( {j}^{2} ) - {E}^{2} ( j )}}$$

where, ρᵢ denotes the similarity of the normalized adsorption isotherm; ρ_{i,j} denotes a Pearson correlation coefficient of two sets of adsorption isotherm data; cov(i,j) denotes a covariance of the two sets of adsorption isotherm data; σᵢ and σⱼ denote standard deviations of the two sets of adsorption isotherm data, respectively; E denotes an expectation; i and j denote the two sets of adsorption isotherm data, respectively; μᵢ and μⱼ denote expectations of the two sets of adsorption isotherm data, respectively; and n denotes a number of samples in the training set.

The saturated adsorption capacity similarity coefficient φᵢ is calculated as follows:

$${φ}_{i} = 1 - \frac{1}{n} {\sum }_{j = 1}^{n} Δ {Q}_{i , j} / MAX ( Δ {Q}_{i , j} )$$

$$Δ {Q}_{i , j} = \vert {Q}_{i} - {Q}_{j} \vert$$

where, φᵢ denotes the saturated adsorption capacity similarity coefficient; MAX denotes a maximum value; Qᵢ and Qⱼ denote saturated adsorption capacities of the i-th and j-th sets of data, respectively; ΔQ_{i,j} denotes a difference in the saturated adsorption capacities; and n denotes the number of samples in the training set.

For ease of understanding, the method and process are described below from the perspectives of various materials and gas types, combined with four exemplary embodiments.

The embodiments of the present disclosure have at least the following beneficial effects. 1. The source of the input data is not limited, and the input data can come from either experiments or simulations. The user only needs to input a single type of adsorption isotherm data for one material to acquire one or more other gas adsorption properties, without the need for experimental testing or theoretical simulation of a plurality of adsorption properties of the material. This greatly saves time and cost. 2. The embodiments of the present disclosure use gas adsorption isotherm as a descriptor, which can be acquired through both experiments and simulations, cleverly avoiding the problem of material modeling. By measuring the adsorption isotherms of some small molecule gases, the present disclosure can predict the adsorption property of materials for gases with complex parameters, under extreme conditions, or even toxic gases based on artificial intelligence. This can not only avoid the problem of limited application scope of simulations but also ensure safety.

### Embodiment 1

Taking an MOF material as an example, the user inputs argon (Ar) adsorption isotherm data at 77 K and requests prediction of the adsorption capacity of the material for n/i-butane at room temperature and 3e+05 Pa. First, the user inputs the Ar adsorption capacities of a specific MOF material at pressure points of 1e−02, 1e−01, 1e+00, 1e+01, 1e+02, 1e+03, 1e+04, and 1e+05 Pa at 77 K through the user terminal, which are 0.18, 1.64, 11.86, 43.90, 191.60, 597.22, 1127.93, and 1239.15 cm³/g, respectively. The user requests prediction of the adsorption capacity of the material for n/i-butane at room temperature and 3e+05 Pa. The input Ar adsorption isotherm data is sufficient and can be connected into a smooth curve. Fitting with the Langmuir equation gives a goodness of fit R² greater than 0.8, which meets the requirements of the subsequent process. Therefore, the data is transmitted to the data storage and processing module. Meanwhile, the adsorption isotherm data of all MOF materials in the database for Ar at 77 K (finally including about 12,000 materials and about 100,000 data entries) and the adsorption capacity for n/i-butane at room temperature and 3e+05 Pa (about 24,000 label values) are extracted. The extracted Ar adsorption isotherm data is fitted using four fitting methods: Langmuir, Quadratic, Brunauer-Emmett-Teller, and dual-site Langmuir. Finally, the dual-site Langmuir fitting method is selected based on the principle of minimum determination coefficient. Based on this, secondary data acquisition is performed. In this embodiment, the values of the Ar adsorption isotherms of all the MOF materials in the training set at the 29 pressure points including 1e−03, 1e−02, 1e−01, 1e+00, 1e+01, 1e+02, 1e+03, 2e+03, 4e+03, 6e+03, 8e+03, 1e+04, 1.2e+04, 1.4e+04, 1.6e+04, 1.8e+04, 2e+04, 2.4e+04, 2.8e+04, 3e+04, 3.2e+04, 3.6e+04, 4e+04, 5e+04, 6e+04, 7e+04, 8e+04, 9e+04, and 1e+05 Pa are acquired as descriptors for subsequent artificial intelligence training. It should be noted that the selection of pressure points during data acquisition is not fixed, but it is necessary to ensure that the pressure points of the adsorption data of all materials are consistent.

500 MOF materials are randomly selected from the extracted MOF materials (accounting for about 4.17% of the extracted MOF materials) to form an initial set. The adsorption data of the remaining MOF materials are compared with the adsorption data of each material in the initial set one by one, and similarities are calculated. The similarities are sorted from low to high, and the first 200 materials are selected and added to the initial set to form an optimized training set (700 MOF materials), and the remaining MOF materials (about 11,000) form a test set.

The acquired data and the corresponding n/i-butane adsorption capacity labels are transmitted to the artificial intelligence training and prediction module. Seven different artificial intelligence models including Decision Tree, Linear Regression, Support Vector Regression (SVR), K-neighbors, Random Forest, eXtreme Gradient Boosting (XGB), and Neural Network are used for training based on the input adsorption data. An optimal model is selected based on the principle of minimum determination coefficient. In this embodiment, the optimal model is Neural Network, which is transmitted to the adsorption property prediction unit to predict the adsorption capacity of the material for n/i-butane at room temperature and 3e+05 Pa. The prediction results are 15.15 mmol/g and 14.83 mmol/g, respectively, which are packaged and transmitted to the user terminal for display and output.

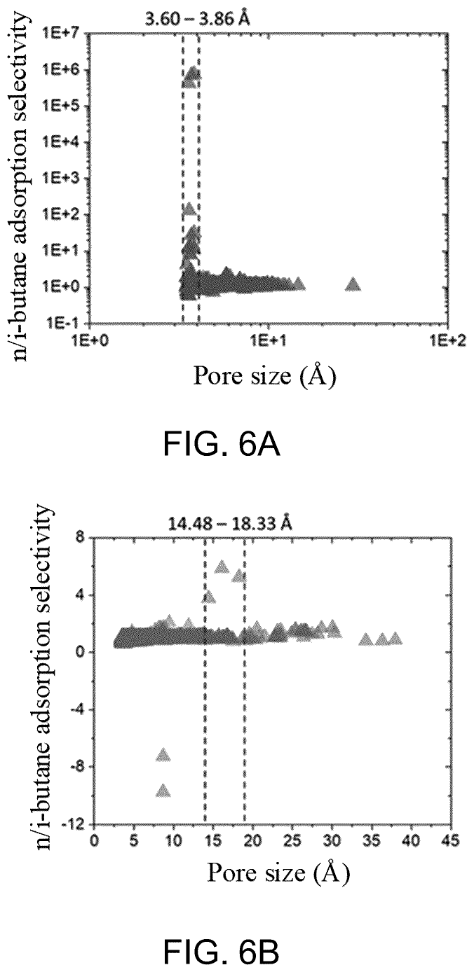

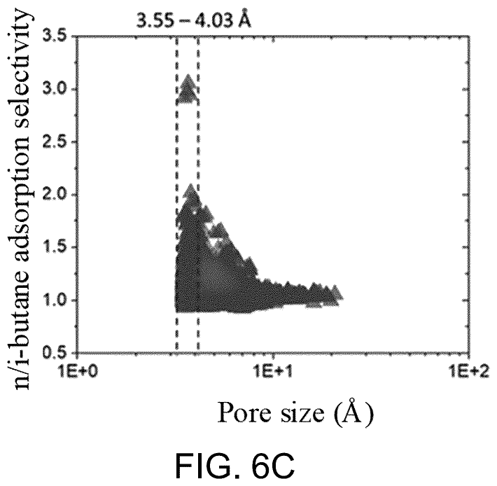

FIGS. 6A, 6B and 6C show a comparison of effects before and after optimizing the training set through the sampling strategy, where FIG. 6A represents the true value, FIG. 6B represents the prediction result of the model before optimizing the training set through the sampling strategy, and FIG. 6C represents the prediction result of the model after optimizing the training set through the sampling strategy. It can be seen that the prediction result of the model before optimizing the training set through the sampling strategy is inaccurate (FIG. 6B), which is mainly reflected in two aspects. (1) The n/i-butane adsorption selectivity has negative values. (2) The pore size range where the maximum n/i-butane adsorption selectivity is located is inconsistent with the actual situation. In contrast, after optimizing the training set through the sampling strategy, the n/i-butane adsorption selectivity is positive, and the pore size range where the maximum adsorption selectivity is located is highly consistent with the actual situation, which proves the advantage of the sampling strategy.

It should be noted that there are various fitting methods and artificial intelligence models, which are not limited to those listed in the embodiment. In addition, the evaluation criteria for fitting effects and training effects of artificial intelligence models are not fixed, and are not limited to the principle of minimum determination coefficient in the exemplary embodiment.

### Embodiment 2

Anion-pillared hybrid MOF materials are a special type of MOF materials. The anion pillars in their structures can serve as selective adsorption sites, making these materials have great potential in the field of gas separation. This embodiment takes an anion-pillared hybrid MOF material as an example. The user inputs CH₄ adsorption isotherm data at room temperature and requests prediction of the working capacity of the material for CO₂ adsorption in the pressure range of 1e+05 to 1e+07 Pa at room temperature. First, the user inputs the CH₄ adsorption capacities of a specific anion-pillared hybrid MOF material at pressure points of 1e+03, 1e+04, 5e+04, 1e+05, 5e+05, 1e+06, 5e+06, and 1e+07 Pa at 298 K through the user terminal, which are 0.048, 0.44, 1.59, 2.39, 4.15, 4.69, 5.46, and 5.65 mmol/g, respectively. The user requests prediction of the working capacity of the material for CO₂ adsorption in the pressure range of 1e+05 to 1e+07 Pa at room temperature. The input CH₄ adsorption isotherm data is sufficient and can be connected into a smooth curve. Fitting with the Langmuir equation gives a goodness of fit R² greater than 0.8, which meets the requirements of the subsequent process. Therefore, the data is transmitted to the data storage and processing module. Meanwhile, the adsorption isotherm data of all anion-pillared hybrid MOF materials in the database for CH₄ at 298 K (the sample includes about 1,000 materials and about 8,000 data entries) and the working capacity of the material for CO₂ adsorption in the pressure range of 1e+05 to 1e+07 Pa at room temperature (the sample label data volume is about 1,000 entries) are extracted. The extracted CH₄ adsorption isotherm data is fitted using four fitting methods: Langmuir, Quadratic, Brunauer-Emmett-Teller, and dual-site Langmuir. Finally, the dual-site Langmuir fitting method is selected based on the principle of minimum determination coefficient. Based on this, secondary data acquisition is completed. In this embodiment, the values of the CH₄ adsorption isotherms of all materials at the 18 pressure points including 1e+00, 1e+01, 1e+02, 1e+03, 5e+03, 1e+04, 3e+04, 5e+04, 7e+04, 1e+05, 3e+05, 5e+05, 7e+05, 1e+06, 3e+06, 5e+06, 7e+06, and 1e+07 Pa are acquired as descriptors for subsequent artificial intelligence training. It should be noted that the selection of pressure points during data acquisition is not fixed, but it is necessary to ensure that the pressure points of the adsorption data of all materials are consistent.

60% of the anion-pillared hybrid MOF materials are randomly selected to form an initial set. The adsorption data of the remaining 40% of the anion-pillared hybrid MOF materials are compared with the adsorption data of each material in the initial set one by one to calculate similarities. The similarities are sorted from low to high. The first half of the materials, i.e., 20% of the total, are selected, and their data are added to the initial set to form an optimized training set, accounting for 80% of the total, and the rest form a test set.

The acquired data and the corresponding CO₂ adsorption working capacity labels are transmitted to the artificial intelligence training and prediction module. Seven different artificial intelligence models including Decision Tree, Linear Regression, SVR, K-neighbors, Random Forest, XGB, and Neural Network are used for training based on the input adsorption data. An optimal model is selected based on the principle of minimum determination coefficient. In this embodiment, the optimal model is Neural Network, which is transmitted to the adsorption property prediction unit to predict the CO₂ adsorption working capacity of the material in the pressure range of 1e+05 to 1e+07 Pa at 298 K. The prediction result is 1.40 mmol/g, which is packaged and transmitted to the user terminal for display and output.

### Embodiment 3

Taking a zeolite material as an example, the user inputs H₂ adsorption isotherm data of the zeolite material at 77 K and requests prediction of the H₂ adsorption capacity of the material at 273 K and 4e+07 Pa. First, the user inputs the H₂ adsorption capacities of a specific zeolite material at pressure points of 1e+05, 2.71e+05, 7.39e+05, 2e+06, 3e+06, 5.5e+06, and 1.5e+07 Pa at 77 K through the user terminal, which are 15.52, 21.55, 25.76, 27.99, 28.44, 28.81, and 29.26 g/L respectively. The user requests prediction of the H₂ adsorption capacity of the material at 273 K and 4e+07 Pa. The input H₂ adsorption isotherm data is sufficient and can be connected into a smooth curve. Fitting with the dual-site Langmuir equation gives a goodness of fit R² greater than 0.8, which meets the requirements of the subsequent process. Therefore, the data is transmitted to the data storage and processing module. Meanwhile, the adsorption isotherm data of all zeolite materials in the database for H₂ at 77 K (the sample includes about 200 materials and about 1,500 data entries) and the H₂ adsorption capacity of the material at 273 K and 4e+07 Pa (the sample label data volume is about 200 entries) are extracted. The extracted H₂ adsorption isotherm data is fitted using four fitting methods: Langmuir, Quadratic, Brunauer-Emmett-Teller, and dual-site Langmuir. Finally, the Langmuir fitting method is selected based on the principle of minimum determination coefficient. Based on this, secondary data acquisition is completed. In this embodiment, the values of the H₂ adsorption isotherms of all materials at the 9 pressure points including 1e+05, 3e+05, 5e+05, 7e+05, 1e+06, 3e+06, 5e+06, 7e+06, and 1e+07 Pa are acquired as descriptors for subsequent artificial intelligence training.

60% of the zeolite materials are randomly selected to form an initial set. The adsorption data of the remaining 40% of the zeolite materials are compared with the adsorption data of each material in the initial set one by one to calculate the similarities. The similarities are sorted from low to high. The first half of the materials, i.e., 20% of the total, are selected, and their data are added to the initial set to form an optimized training set, accounting for 80% of the total, and the rest form a test set.

The acquired data and the corresponding H₂ adsorption capacity labels are transmitted to the artificial intelligence training and prediction module. Seven different artificial intelligence models including Decision Tree, Linear Regression, SVR, K-neighbors, Random Forest, XGB, and Neural Network are used for training based on the input adsorption data. An optimal model is selected based on the principle of minimum determination coefficient. In this embodiment, the optimal model is Random Forest, which is transmitted to the adsorption property prediction unit to predict the H₂ adsorption capacity of the material at 273 K and 4e+07 Pa. The prediction result is 6.19 g/L, which is packaged and transmitted to the user terminal for display and output.

### Embodiment 4

Taking an amorphous material as an example, the user inputs N₂ adsorption isotherm data of the amorphous material at 77 K and requests prediction of the Ar adsorption capacity of the material at 77 K and 1e+05 Pa. First, the user inputs the N₂ adsorption capacities of a specific amorphous material at pressure points of 1e−1, 1e+00, 1e+01, 5e+01, 1e+02, 5e+02, 1e+03, 2e+03, 5e+03, 1e+04, 2e+04, 5e+04, and 1e+05 Pa at 77 K through the user terminal, which are 12.16, 16.71, 21.47, 25.61, 27.07, 31.76, 34.21, 35.53, 40.60, 42.29, 46.25, 47.97, and 49.58 cm³/g respectively. The user requests prediction of the Ar adsorption capacity of the material at 77 K and 1e+05 Pa. The input N₂ adsorption isotherm data is sufficient and can be connected into a smooth curve. Fitting with the dual-site Langmuir equation gives a goodness of fit R² greater than 0.8, which meets the requirements of the subsequent process. Therefore, the data is transmitted to the data storage and processing module. Meanwhile, the adsorption isotherm data of all amorphous materials in the database for N₂ at 77 K (the sample includes about 600 materials and about 8,000 data entries) and the Ar adsorption capacity of the material at 77 K and 1e+05 Pa (the sample label data volume is about 600 entries) are extracted. The extracted N₂ adsorption isotherm data is fitted using four fitting methods: Langmuir, Quadratic, Brunauer-Emmett-Teller, and dual-site Langmuir. Finally, the dual-site Langmuir fitting method is selected based on the principle of minimum determination coefficient. Based on this, secondary data acquisition is completed. In this embodiment, the values of the N₂ adsorption isotherms of all materials at the 10 pressure points including 1e+00, 1e+01, 3e+01, 1e+02, 3e+02, 1e+03, 3e+03, 1e+04, 3e+04, and 1e+05 Pa are acquired as descriptors for subsequent artificial intelligence training.

60% of the amorphous materials are randomly selected to form an initial set. The adsorption data of the remaining 40% of the amorphous materials are compared with the adsorption data of each material in the initial set one by one to calculate similarities. The similarities are sorted from low to high. The first half of the materials, i.e., 20% of the total, are selected, and their data are added to the initial set to form an optimized training set, accounting for 80% of the total, and the rest form a test set.

The acquired data and the corresponding Ar adsorption capacity labels are transmitted to the artificial intelligence training and prediction module. Seven different artificial intelligence models including Decision Tree, Linear Regression, SVR, K-neighbors, Random Forest, XGB, and Neural Network are used for training based on the input adsorption data. An optimal model is selected based on the principle of minimum determination coefficient. In this embodiment, the optimal model is Random Forest, which is transmitted to the adsorption property prediction unit to predict the Ar adsorption capacity of the material at 77 K and 1e+05 Pa. The prediction result is 60.86 cm³/g, which is packaged and transmitted to the user terminal for display and output.

Compared with the prior art, the present disclosure has the following advantages:

1. The present disclosure defines a sampling strategy according to the actual situation of the gas adsorption descriptor of the material and optimizes the training set based on the sampling strategy. In this way, the present disclosure reduces the artificial intelligence training cost and significantly improves the accuracy of the artificial intelligence model.

2. Different from the descriptor types commonly used in the prior art, the present disclosure adopts a simulation-experiment-integrated descriptor, namely gas adsorption isotherm, to train the artificial intelligence model. The descriptor can be theoretically calculated and easily acquired through experiments. The present disclosure can acquire the adsorption property of a material for one or more other gases only by inputting the adsorption data of the material for one gas acquired through an experiment or simulation. Therefore, the present disclosure reduces the research and development costs of adsorption materials and improves research and development efficiency.

It is apparent to those skilled in the art that the present disclosure is not limited to details of the above exemplary embodiments, and that the present disclosure may be implemented in other specific forms without departing from spirit or basic features of the present disclosure. Therefore, the embodiments should be regarded as exemplary and non-limiting in every respect. The scope of the present disclosure is defined by the appended claims rather than the above description, therefore, all changes falling within the meaning and scope of equivalent elements of the claims should be included in the present disclosure, and any reference numerals in the claims should not be construed as a limitation to the claims involved.

What is claimed is:

1. A method for rapidly predicting a gas adsorption property of a material based on artificial intelligence, comprising following steps:
S1: acquiring, by a user, gas adsorption property data of the material, and determining a gas adsorption property label to be predicted; and retrieving gas adsorption property data of same-type materials from a database, and dividing the gas adsorption property data of the same-type materials into a training set and a validation set; and
S2: constructing a prediction model based on the training set, and validating the prediction model based on the validation set to obtain a validated prediction model; and predicting, by the validated prediction model, the gas adsorption property of the material;
wherein, the gas adsorption property data retrieved from the database comprises gas adsorption property data corresponding to the gas adsorption property of the material and gas adsorption property data corresponding to the gas adsorption property label to be predicted;
the dividing of the gas adsorption property data of the same-type materials into the training set and the validation set comprises: randomly selecting a part of the gas adsorption property data of the same-type materials as an initial set, selecting and supplementing a part of remaining gas adsorption property data with a lower similarity to the initial set into the initial set to obtain the training set, and taking a remaining part of the remaining gas adsorption property data as the validation set;
wherein, a similarity is calculated by summing a similarity of a normalized adsorption isotherm and a saturated adsorption capacity similarity coefficient;
the similarity of the normalized adsorption isotherm is calculated from two sets of adsorption isotherm data as follows:
$${ρ}_{i} = \frac{1}{n} {\sum }_{j = 1}^{n} {ρ}_{i , j} ;$$
$${ρ}_{i , j} = \frac{cov ( i , j )}{{σ}_{i} {σ}_{j}} = \frac{E ( ( i - {μ}_{i} ) ( j - {μ}_{j} ) )}{{σ}_{i} {σ}_{j}} = \frac{E ( ij ) - E ( i ) E ( j )}{\sqrt{E ( {i}^{2} ) - {E}^{2} ( i )} \sqrt{E ( {j}^{2} ) - {E}^{2} ( j )}} ;$$
wherein, ρᵢ denotes the similarity of the normalized adsorption isotherm; ρ_{i,j} denotes a Pearson correlation coefficient of the two sets of adsorption isotherm data; cov(i,j) denotes a covariance of the two sets of adsorption isotherm data; σᵢ and σⱼ denote standard deviations of the two sets of adsorption isotherm data, respectively; E denotes an expectation; i and j denote the two sets of adsorption isotherm data, respectively; μᵢ and μⱼ denote expectations of the two sets of adsorption isotherm data, respectively; and n denotes a number of samples in the training set; and
the saturated adsorption capacity similarity coefficient is calculated as follows:
$${φ}_{i} = 1 - \frac{1}{n} {\sum }_{j = 1}^{n} Δ {Q}_{i , j} / MAX ( Δ {Q}_{i , j} ) ;$$
$$Δ {Q}_{i , j} = \vert {Q}_{i} - {Q}_{j} \vert ;$$
wherein, φᵢ denotes the saturated adsorption capacity similarity coefficient; MAX denotes a maximum value; Qᵢ and Qⱼ denote saturated adsorption capacities of the two sets of adsorption isotherm data i and j, respectively; ΔQ_{i,j} denotes a difference in the saturated adsorption capacities; and n denotes the number of samples in the training set.

2. The method for rapidly predicting the gas adsorption property of the material based on artificial intelligence according to claim 1, wherein the gas adsorption property refers to one of an adsorption capacity, an adsorption rate, and a desorption rate for a predetermined gas type under a predetermined parameter condition; and the gas adsorption property label to be predicted refers to gas adsorption properties under different parameter conditions and/or for different gas types;
the different parameter conditions refer to different temperatures and/or different pressures; and
a number of types of the same-type materials retrieved from the database is greater than or equal to a number of types of the material acquired by the user.

3. The method for rapidly predicting the gas adsorption property of the material based on artificial intelligence according to claim 1, wherein a gas type is one selected from a group consisting of methane, ethane, n-hexane, toluene, ethyl acetate, nitrogen, argon, carbon dioxide, ethylene, propylene, butylene, methanol, ethanol, acetone, chloroform, benzene, xylene, carbon tetrachloride, ammonia, hydrogen sulfide, carbon monoxide, oxygen, ozone, chlorine, fluorine, bromine, iodomethane, and styrene; and
a type of the material is one selected from a group consisting of activated carbon, metal-organic framework, covalent organic framework, molecular sieve, carbon nanotube, ceramic, and porous coordination polymer.

4. The method for rapidly predicting the gas adsorption property of the material based on artificial intelligence according to claim 1, comprising: fitting the gas adsorption property data acquired by the user and/or the gas adsorption property data retrieved from the database through a gas adsorption equation, and generating gas adsorption property data under another condition.

5. The method for rapidly predicting the gas adsorption property of the material based on artificial intelligence according to claim 1, further comprising: determining completeness of the gas adsorption property data acquired by the user by fitting the gas adsorption property data acquired by the user through a gas adsorption equation, determining whether a fitting degree meets a threshold requirement, and determining that the gas adsorption property data acquired by the user is complete if the threshold requirement is met.

6. The method for rapidly predicting the gas adsorption property of the material based on artificial intelligence according to claim 5, wherein the gas adsorption equation is one selected from a group consisting of Langmuir equation, Brunauer-Emmett-Teller (BET) equation, Freundlich equation, Temkin equation, Dubinin-Radushkevich equation, Toth equation, Sips equation, or Zeta adsorption model; and the fitting degree is measured through one of determination coefficient, mean squared error, root mean squared error, mean absolute error, mean absolute percentage error, residual, Akaike information criterion (AIC), or Bayesian information criterion (BIC).

7. A system for rapidly predicting a gas adsorption property of a material based on artificial intelligence, comprising:
a user terminal, configured for a user to acquire gas adsorption property data of the material and determine a gas adsorption property label to be predicted;
a data storage and processing module, configured to extract gas adsorption property data of same-type materials and divide the gas adsorption property data of the same-type materials into a training set and a validation set; and
an artificial intelligence training and prediction module, configured to construct a prediction model based on the training set and validate the prediction model based on the validation set;
wherein, gas adsorption property data retrieved from a database comprises gas adsorption property data corresponding to the gas adsorption property label to be predicted;
the gas adsorption property data of the same-type materials is divided into the training set and the validation set by randomly selecting a part of the gas adsorption property data of the same-type materials as an initial set, selecting and supplementing a part of remaining gas adsorption property data with a lower similarity to the initial set into the initial set to obtain the training set, and taking a remaining part of the remaining gas adsorption property data as the validation set;
wherein, a similarity is calculated by summing a similarity of a normalized adsorption isotherm and a saturated adsorption capacity similarity coefficient;
the similarity of the normalized adsorption isotherm is calculated from two sets of adsorption isotherm data as follows:
$${ρ}_{i} = \frac{1}{n} {\sum }_{j = 1}^{n} {ρ}_{i , j} ;$$
$${ρ}_{i , j} = \frac{cov ( i , j )}{{σ}_{i} {σ}_{j}} = \frac{E ( ( i - {μ}_{i} ) ( j - {μ}_{j} ) )}{{σ}_{i} {σ}_{j}} = \frac{E ( ij ) - E ( i ) E ( j )}{\sqrt{E ( {i}^{2} ) - {E}^{2} ( i )} \sqrt{E ( {j}^{2} ) - {E}^{2} ( j )}} ;$$
wherein, ρᵢ denotes the similarity of the normalized adsorption isotherm; ρ_{i,j} denotes a Pearson correlation coefficient of the two sets of adsorption isotherm data; cov(i,j) denotes a covariance of the two sets of adsorption isotherm data; σᵢ and σⱼ denote standard deviations of the two sets of adsorption isotherm data, respectively; E denotes an expectation; i and j denote the two sets of adsorption isotherm data, respectively; μᵢ and μⱼ denote expectations of the two sets of adsorption isotherm data, respectively; and n denotes a number of samples in the training set;
the saturated adsorption capacity similarity coefficient is calculated as follows:
$${φ}_{i} = 1 - \frac{1}{n} {\sum }_{j = 1}^{n} Δ {Q}_{i , j} / MAX ( Δ {Q}_{i , j} ) ;$$
$$Δ {Q}_{i , j} = \vert {Q}_{i} - {Q}_{j} \vert ;$$
wherein, φᵢ denotes the saturated adsorption capacity similarity coefficient; MAX denotes a maximum value; Qᵢ and Qⱼ denote saturated adsorption capacities of the two sets of adsorption isotherm data i and j, respectively; ΔQ_{i,j} denotes a difference in the saturated adsorption capacities; and n denotes the number of samples in the training set.

8. The system for rapidly predicting the gas adsorption property of the material based on artificial intelligence according to claim 7, wherein the gas adsorption property refers to one of an adsorption capacity, an adsorption rate, and a desorption rate for a predetermined gas type under a predetermined parameter condition; and the gas adsorption property label to be predicted refers to gas adsorption properties under different parameter conditions and/or for different gas types; and
the user terminal further comprises a determination unit configured to determine completeness of the gas adsorption property data acquired by the user by fitting the gas adsorption property data acquired by the user through a gas adsorption equation, determining whether a fitting degree meets a threshold requirement, and determining that the gas adsorption property data acquired by the user is complete if the threshold requirement is met.

9. The system for rapidly predicting the gas adsorption property of the material based on artificial intelligence according to claim 8, wherein the data storage and processing module further comprises a secondary acquisition unit configured to fit the gas adsorption property data acquired by the user and/or the gas adsorption property data retrieved from the database through the gas adsorption equation, and generate gas adsorption property data under another condition;
the data storage and processing module further comprises a training-validation set splitting unit configured to randomly select a part of the gas adsorption property data of the same-type materials as an initial set, select and supplement a part of remaining gas adsorption property data with a lower similarity to the initial set into the initial set to obtain the training set, and take a remaining part of the remaining gas adsorption property data as the validation set; and
the artificial intelligence training and prediction module further comprises a model evaluation unit configured to compare performances of prediction models trained based on different artificial intelligence models.
